(19) United States
(12) Patent Application Publication
(10) Pub. No.: US 2012/0137087 A1
(43) Pub. Date: May 31, 2012

(54) STORAGE AREA MANAGEMENT APPARATUS FOR MANAGING STORAGE AREAS PROVIDED FROM UPPER APPARATUSES, AND CONTROL METHOD AND STORAGE MEDIUM THEREFOR

(75) Inventor: Kiyokazu Umimura, Kawasaki-shi (JP)

(73) Assignee: CANON KABUSHIKI KAISHA, Tokyo (JP)

(21) Appl. No.: 13/289,608

(22) Filed: Nov. 4, 2011

(30) Foreign Application Priority Data
Nov. 29, 2010 (JP) 2010-264957

(51) Int. Cl. G06F 12/00

(52) U.S. Cl. 711/154; 711/E12.001

(57) ABSTRACT

A storage area management apparatus capable of preventing a particular one or ones of storage units of upper apparatuses from being concentratedly accessed, thereby equalizing remaining lifetimes of the storage units. The management apparatus is connected to upper apparatuses through a network, computes lifetime values representing lifetimes of provided areas respectively provided from the storage units of the upper apparatuses, and controls the upper apparatuses based on the computed lifetime values such that provided areas having longer remaining lifetimes are used for data storage with higher priorities.

### BACKGROUND OF THE INVENTION

1. Field of the Invention

The present invention relates to a storage area management apparatus and a control method and a storage medium therefor. More particularly, the present invention relates to an apparatus for managing storage areas provided from storage units of upper apparatuses, and a control method and a storage medium therefor.

2. Description of the Related Art

Recent image forming apparatuses (hereinafter, referred to as the MFPs) are each mounted with a nonvolatile storage unit such as an HDD or an SSD for use as a temporary storage of image data. The storage unit has a storage area a part of which can be provided to a user for data storage.

With the above arrangement, individual MFPs have independent storages. In other words, the storage capacity for each MFP is fixed. Accordingly, if the storage capacity is small, the capacity of available data storage area is limited. On the other hand, if a large-capacity HDD is used to increase the storage capacity, a disk mass increases, resulting in increase in the startup time and cost of the MFP. As for data storage, various data are dispersedly stored in the storages of respective MFPs, and therefore the user cannot access desired data without ascertaining in which of the storages the desired data is stored, which impairs user-friendliness.

To eliminate the above drawbacks, there has been proposed a method in which storages provided from network-connected MFPs are integrated into one storage (hereinafter, referred to as the big box) on the network.

With the proposed method, each user can access the integrated storage from any of the MFPs and is not required to ascertain a data storage destination, resulting in improved user-friendliness.

As a storage sharing method, there has been proposed a data communication system in which a printer mounts a storage of a computer and supplies the contents of the storage to other computers, thereby enabling data sharing (see, for example, Japanese Laid-open Patent Publication No. 2002-215347).

With the data communication system, however, if the storage which the printer mounts becomes unusable, e.g., due to power-off of the computer, the storage becomes unable to respond to a request for access from other computers and the big box becomes unable to function.

In the case of using HDDs, which are limited in the number of ON/OFF times, as storages of MFPs constituting the big box, if one of the HDDs is concentratedly accessed, the number of ON/OFF times of the HDD increases and the end of the lifetime of the HDD is reached earlier, so that the big box becomes unable to function.

In the case of using SSDs limited in the number of block deletion times as storages of MFPs constituting the big box, if one of the SSDs is concentratedly accessed, the number of deletion times of the SSD increases and the end of the write-lifetime of the SSD is reached earlier, resulting in the big box becoming nonfunctional.

As described above, the prior art has a drawback that the big box becomes unable to function, if a particular one or ones of storage units constituting the big box are concentratedly accessed.

### SUMMARY OF THE INVENTION

The present invention provides a storage area management apparatus, and a control method and a storage medium therefor, which are capable of preventing a particular one or ones of storage units of upper apparatuses from being concentratedly accessed, thereby equalizing remaining lifetimes of the storage units.

According to one aspect of this invention, there is provided a storage area management apparatus for managing, as one storage area, a plurality of storage areas respectively provided from nonvolatile storage units of respective ones of upper apparatuses, which comprises a computation unit configured to compute lifetime values representing lifetimes of the plurality of storage areas, and a storage control unit configured to control the upper apparatuses based on the lifetime values computed by the computation unit such that storage areas having longer remaining lifetimes, among the plurality of storage areas, are used for data storage with higher priority order.

With this invention, a particular one or ones of the storage unit of the upper apparatuses can be prevented from being concentratedly accessed, whereby remaining lifetimes of the storage units can be equalized.

Further features of the present invention will become apparent from the following description of an exemplary embodiment with reference to the attached drawings.

### BRIEF DESCRIPTION OF THE DRAWINGS

FIG. 1 is a view schematically showing a system that includes MFPs and includes a storage area management apparatus according to one embodiment of this invention;

FIG. 2 is a block diagram schematically showing the construction of the storage area management apparatus;

FIG. 3 is a block diagram schematically showing the construction of one of the MFPs;

FIG. 4 is a schematic view showing storage areas that can be provided as a big box from storages of the MFPs;

FIG. 5 is a schematic view showing storage areas that are provided as the big box from the storages of the MFPs;

FIG. 6 is a view showing a management table stored in an HDD of the management apparatus;

FIG. 7 is a flowchart showing procedures of a data storage process performed by the management apparatus in a case where SSDs are used as the storages of the MFPs;

FIG. 8 is a view showing an example of lifetime values of storages;

FIG. 9 is a view showing a provided area changing process in which when the lifetime value of the provided area of any of the storages of the MFPs exceeds a predetermined value, an auxiliary area of the storage is set as a new provided area;

FIG. 10 is a view showing a provided area changing process in which when the lifetime value of the providable area of any of the storages of the MFPs exceeds a predetermined value, an auxiliary area of the storage of another MFP is set as a new provided area;

FIG. 11 is a flowchart showing procedures of a provided area changing process executed by the management apparatus;

FIG. 12 is a flowchart showing procedures of a data movement process executed by the management apparatus;

FIG. 13 is a view showing an example of a warning that is displayed on an operation unit of one of the MFPs;

FIG. 14 is a flowchart showing procedures of a data storage process executed by the management apparatus in a case where HDDs are used as the storages of the MFPs;

FIG. 15 is a flowchart showing procedures of a data storage process executed by the management apparatus in a case where HDDs and SSDs are used as the storages of the MFPS with a higher priority to the HDDs than to SSDs; and

FIG. 16 is a flowchart showing procedures of a data storage process executed by the management apparatus in a case where HDDs and SSDs are used as the storages of the MFPS with a higher priority to either HDDs or SSDs, whichever have longer lifetime values.

### DESCRIPTION OF THE EMBODIMENTS

The present invention will now be described in detail below with reference to the drawings showing a preferred embodiment thereof.

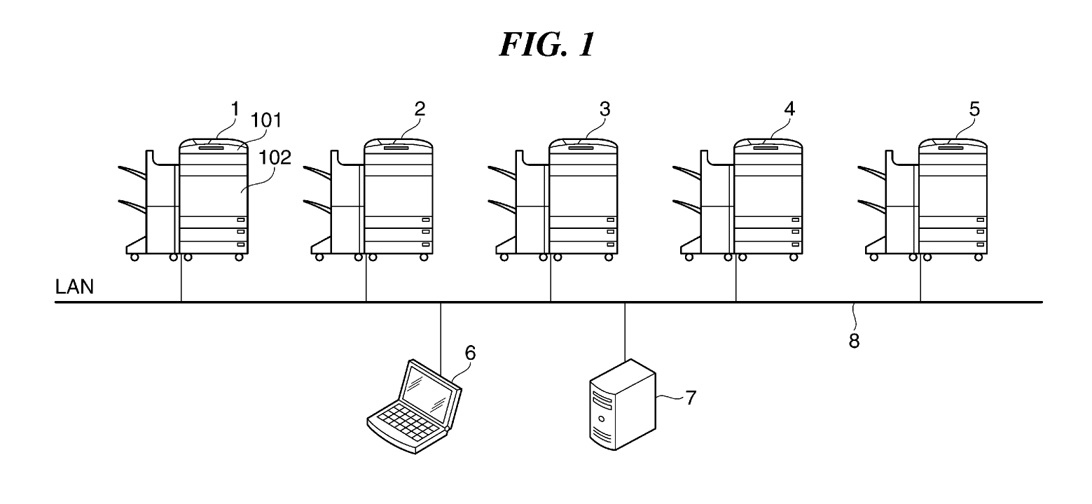

FIG. 1 schematically shows a system that includes a storage area management apparatus (hereinafter, referred as the management apparatus) according to one embodiment of this invention.

As shown in FIG. 1, the management apparatus 7 is connected to a plurality of upper apparatuses (e.g., five image forming apparatuses (hereinafter, referred to as the MFPs) 1 to 5) and to a PC 6 through a LAN 8. The management apparatus 7 manages as one storage area a plurality of storage areas respectively provided from nonvolatile storage units of respective ones of the MFPs 1 to 5. The MFPs 1 to 5 are the same as one another in construction and function.

The construction of the system shown in FIG. 1 is an example and not limitative. The system can have any construction so long as it includes the management apparatus 7 and upper apparatuses each having a nonvolatile storage unit.

The PC 6, which is a host computer, has the same hardware structure as that of an ordinary server and includes a CPU, ROM, RAM, etc. The PC 6 is capable of transmitting and receiving a file and an e-mail through the LAN 8 by using FTP protocol or SMB protocol, and is capable of giving a print instruction to any of the MFPs 1 to 5 through a printer driver.

The MFP 1 includes a scanner unit 101 serving as an image input device and a printer unit 102 serving as an image output device.

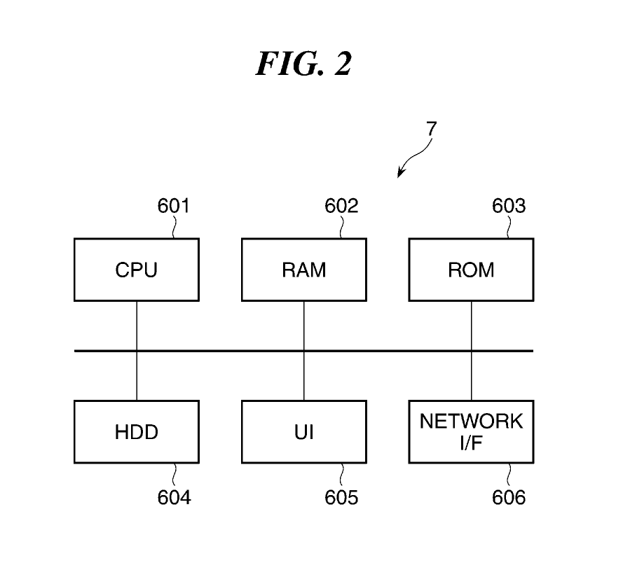

FIG. 2 schematically shows in block diagram the construction of the management apparatus 7.

As shown in FIG. 2, the management apparatus 7 includes a CPU 601, RAM 602, ROM 603, HDD 604, UI 605, and network interface 606, as with an ordinary computer.

The CPU 601 controls the entire management apparatus 7 and executes various processes described later. The RAM 602 is a volatile memory in which a program and data are developed. The ROM 603 is a nonvolatile memory that stores a BIOS, etc. The HDD 604 is a hard disk drive, which is a nonvolatile storage unit for storing a program and data. The UI 605 is a user interface that includes a monitor, keyboard, pointing device, etc. The network interface 606 is an interface for connection with the LAN 8.

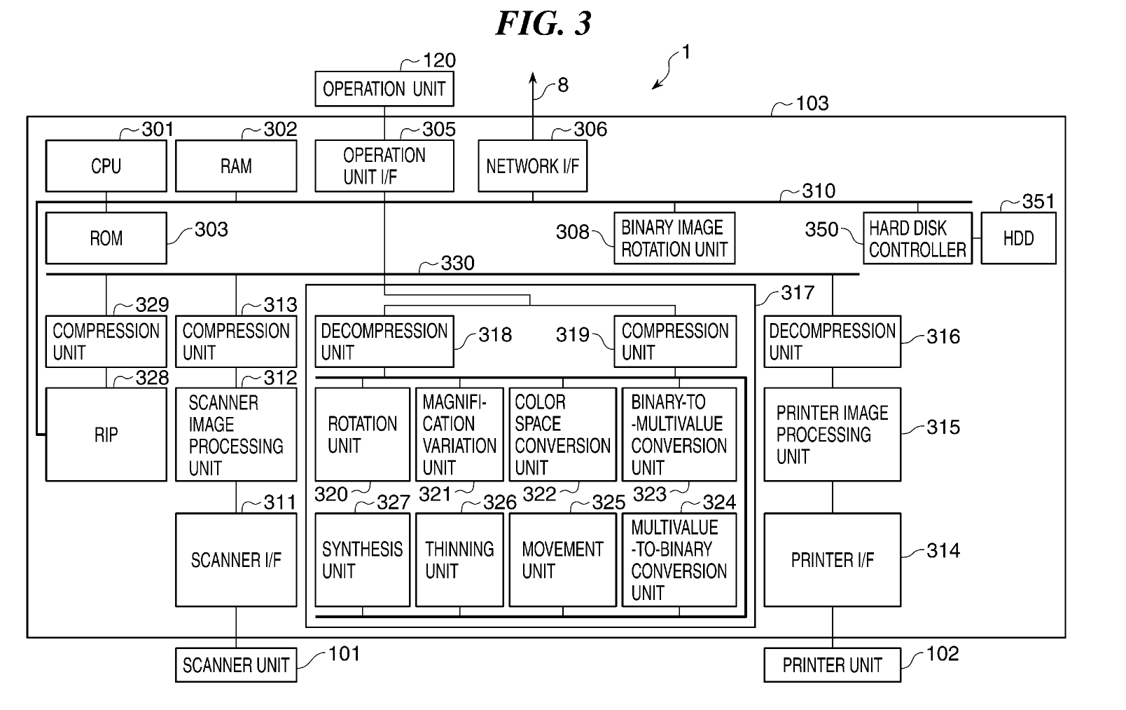

FIG. 3 schematically shows in block diagram the construction of the MFP 1.

As shown in FIG. 3, the MFP 1 includes a controller 103, scanner unit 101, printer unit 102, and operation unit 120.

When supplied with an original reading instruction from the controller 103 according to a user's operation, the scanner unit 101 exposes and scans an original, inputs light reflected from the original into a CCD where an original image is converted into RGB electrical signals, and outputs the signals to the controller 103.

The printer unit 102 is an image forming device that receives image data from the controller 103 and forms the received image data on a sheet.

The controller 103 is electrically connected to the scanner unit 101 and the printer unit 102, and is capable of communicating image data and device information with the PC 6 and external devices through the LAN 8.

The controller 103 includes a CPU 301, RAM 302, ROM 303, operation unit interface 305, network interface 306, binary image rotation unit 308, hard disk controller 350, HDD 351 (hard disk drive), compression units 313, 329, RIP 328, scanner image processing unit 312, scanner interface 311, image conversion unit 317, decompression unit 316, printer image processing unit 315, and printer interface 314, which are connected to one another through a system bus 310 and an image bus 330.

Based on programs, etc., stored in the ROM 303, the CPU 301 centrally controls access from devices being connected and centrally controls various processing performed inside the controller 103. The RAM 302 serves as a system work memory for use by the CPU 301 for its operation and serves as a memory for temporarily storing image data. The RAM 302 is comprised of an SRAM capable of holding stored contents even after power-off and a DRAM whose stored contents are erased at power-off. The ROM 303 stores a boot program for the MFP 1.

The hard disk controller 350 is connected with the HDD 351 having a hard disk capable of storing system software and image data. In the MFP 1 shown in FIG. 3, the HDD 351 is used as a nonvolatile storage unit, but an SSD can be used instead. In the following, the nonvolatile storage unit will be sometimes referred to as the storage.

The operation unit I/F 305 is an interface unit through which the system bus 310 is connected to the operation unit 120. The operation unit I/F 305 receives through the system bus 310 image data to be displayed on the operation unit 120, outputs the received image data to the operation unit 120, and outputs to the system bus 310 information input from the operation unit 120.

The network interface 306 is an interface through which the system bus 310 is connected to the LAN 8 for input and output of information.

The image bus 330, which is a transmission line for image data, is implemented by a PCI bus.

The scanner image processing unit 312 performs correction, processing, and editing on image data received from the scanner unit 101 through the scanner interface 311. The scanner image processing unit 312 determines, e.g., whether the received image data corresponds to a color original or a monochrome original or corresponds to a character original or a photographic original, and attaches image area data representing a result of the determination to the image data. The compression unit 313 receives image data from the scanner image processing unit 312, and divides the received image data into blocks, each 32×32 pixels in size.

The printer image processing unit 315 performs image processing to obtain image data to be output to the printer unit 102 from image data decompressed by the decompression unit 316, and outputs the processed image data to the printer interface 314.

The image conversion unit 317 that performs image conversions includes a decompression unit 318, compression unit 319, rotation unit 320, magnification variation unit 321, color space conversion unit 322, binary-to-multivalue conversion unit 323, synthesis unit 327, thinning unit 326, movement unit 325, and multivalue-to-binary conversion unit 324, which are conventionally known.

The following is a description of a copy operation performed by the MFP 1 having the construction described above.

Image data read by the scanner unit 101 is transmitted to the scanner image processing unit 312 through the scanner interface 311. Next, the compression unit 313 divides the image data received from the scanner image processing unit 312 into blocks (each 32×32 pixels in size) to thereby generate pieces of tile data, and compresses image data constituted by the tile data. The compressed image data is transmitted to and stored into the RAM 302. It should be noted that the image data is output, where required, to the image conversion unit 317 in which image processing is performed on the image data and from which the processed data is again transmitted to and stored into the RAM 302.

Image data read from the RAM 302 is stored into the hard disk 351 and can be read from the hard disk 351 and output to the system bus 310. The reason why the image data is temporarily stored into the hard disk 351 is that a work area is sometimes required for transposition of pages or the like.

Subsequently, the image data is output from the bus 310 to the decompression unit 316 that decompresses the image data and performs raster development of the decompressed image data constituted by plural pieces of tile data. The image data after the raster development is output to the printer image processing unit 315, and the image data processed in the processing unit 315 is output to the printer unit 102 through the printer interface 314.

Next, an operation of the MFP 1 for printing data written in PDL will be described.

PDL data output from the PC 6 is transmitted to the MFP 1 through the LAN 8 and received by the network interface 306 from which the received data is transmitted to and stored into the RAM 302. The PDL data is analyzed by the CPU 301, and intermediate data generated based on a result of the analysis is output to the RIP 328. The RIP 328 performs rendering of the intermediate data, thereby generating image data in raster form and outputting it to the compression unit 329. The compression unit 329 divides the image data into blocks and compresses the resultant data, which is output to and stored into the RAM 302.

The image data stored into the RAM 302 is read therefrom and written into the hard disk 351. Next, the image data is read from the hard disk 351, is output to the printer unit 102 through the bus 310 and the like, and is printed onto a sheet by the printer unit 102.

Next, an operation of the MFP 1 for storing image data of an original read by the scanner unit 101 will be described.

Image data of an original read by the scanner unit 101 is output to the scanner image processing unit 312 through the scanner I/F 311.

Next, the compression unit 313 divides the image data received from the scanner image processing unit 312 into blocks (each 32×32 pixels in size) to thereby generate pieces of tile data, and compresses the image data constituted by the tile data. The image data compressed by the compression unit 313 is stored into the RAM 302. It should be noted that the image data is sent, where required, to the image conversion unit 317 in which image processing is performed on the image data and the processed data is again stored into the RAM 302.

Subsequently, the image data is read from the RAM 302, a file name is added to the image data according to user's setting, and the resultant data is stored into a predetermined directory of the hard disk 351.

Next, an operation of the MFP 1 for calling data stored in the hard disk 351 will be described.

Data stored in the hard disk 351 is called by the hard disk controller 350, is output to the bus 310, and is subjected to processing according to the user's setting, such as being displayed on the operation unit 120 and being transmitted to a predetermined mail address.

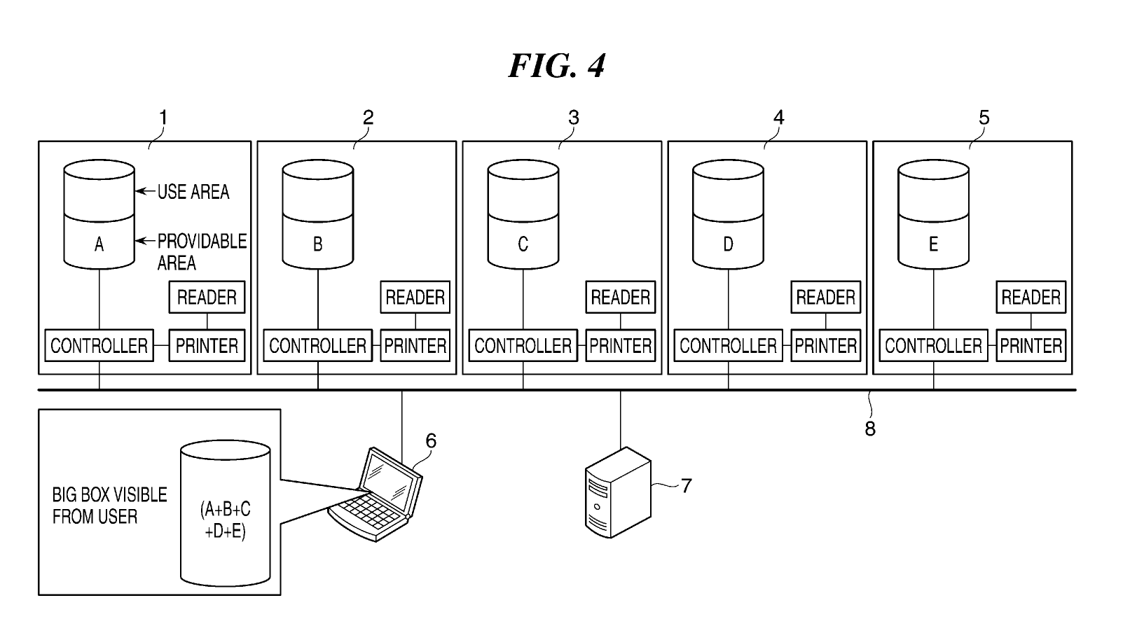

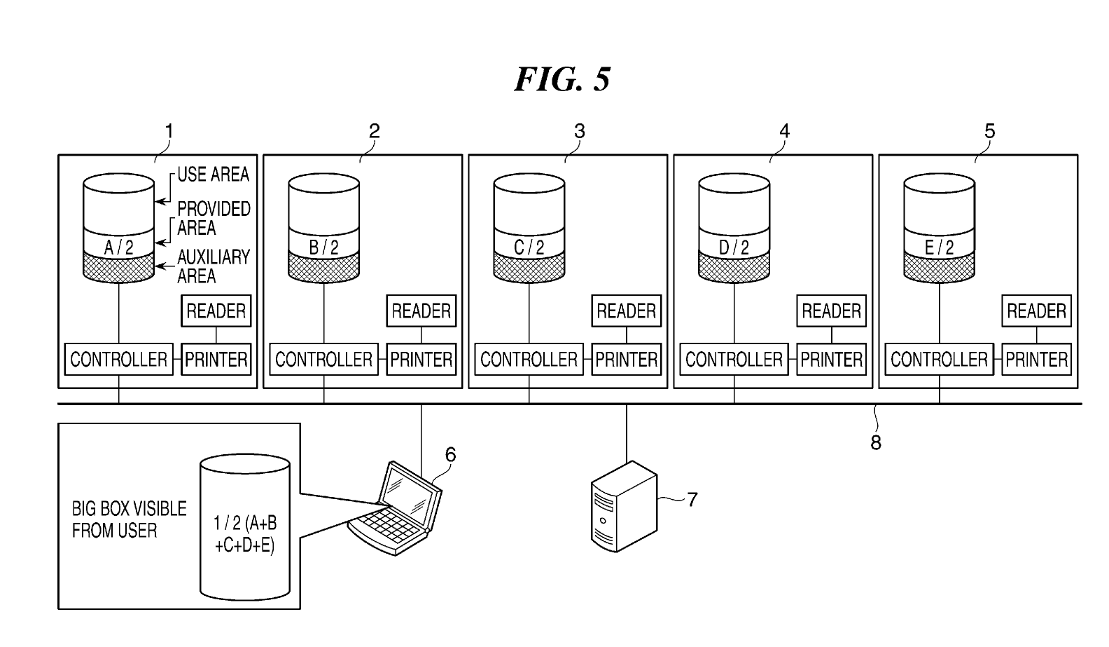

FIG. 4 schematically shows storage areas that can be provided as a big box from the storages of the MFPs 1 to 5, and FIG. 5 schematically shows storage areas that are provided as the big box from the storages of the MFPs 1 to 5.

As shown in FIG. 4, the storage of each of the MFPs 1 to 5 is divided into a storage area for use by the MFP (hereinafter, referred to as the use area) and a storage area that can be provided as a part of the big box (hereinafter, referred to as the providable area). The providable areas of the storages of the MFPs 1 to 5 are respectively represented by symbols A to E. The providable areas A to E are partly used as the big box. In the following, storage areas used as the big box among the providable areas A to E will be referred to as the provided areas, and the remaining storage areas of the providable areas A to E will be referred to as the auxiliary areas.

The management apparatus 7 recognizes the providable areas A to E of the MFPs 1 to 5, decides what portions of the providable areas should be used as the provided areas, and retains the decided result in a management table.

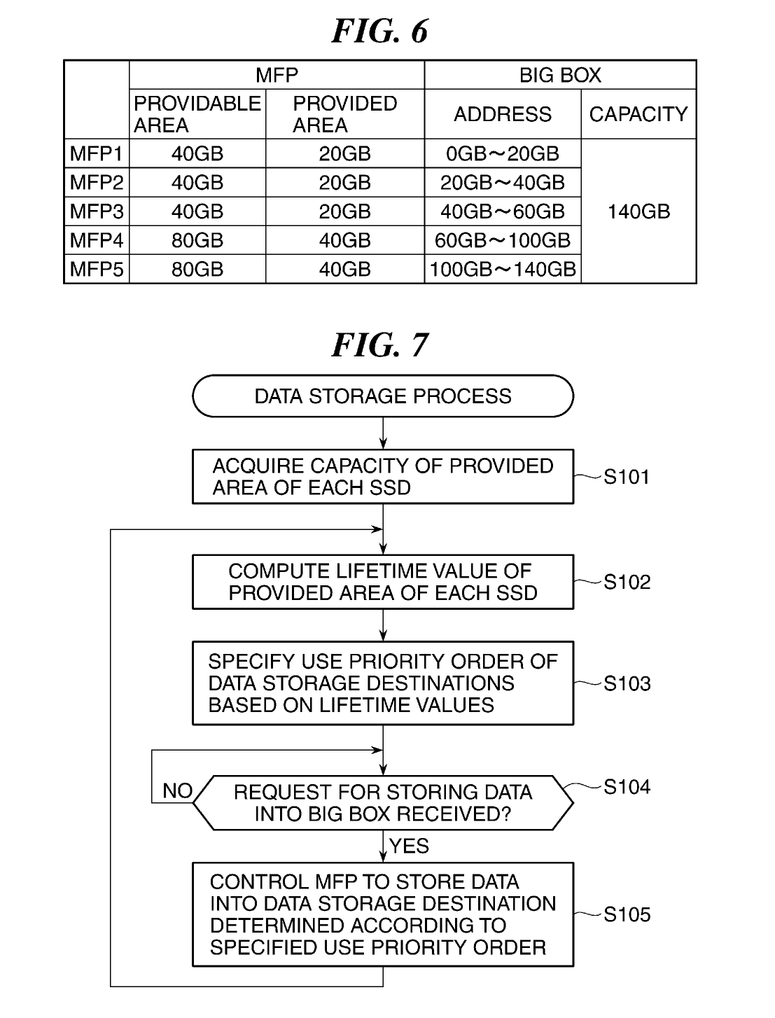

FIG. 6 shows a management table stored in the HDD 604 of the management apparatus 7.

As shown in FIG. 6, the management table has an “MFP” field and “big box” field. The “MFP” field includes a “providable area” field in which the capacities of the providable areas A to E of the storages of the MFPs 1 to 5 are indicated and a “provided area” field in which the capacities of the provided areas of the storages of the MFPs 1 to 5 are indicated. The “big box” field includes an “address” field in which address regions in the big box to which the provided areas of the storages of the MFPs 1 to 5 are assigned are indicated and a “capacity” field in which the capacity of the entire big box is indicated.

In the illustrated example, the provided areas (denoted by symbols A/2 to E/2) are set to be half of the providable areas A to E, and the remaining areas of the providable areas A to E are set as the auxiliary areas, as shown in FIG. 5. The ratio of each provided area to the corresponding providable area can be specified by the management apparatus 7 or by the user. The big box has a total capacity of 140 GB in the illustrated example.

Each of the PC 6 and the MFPs 1 to 5 accesses the management apparatus 7 through the LAN 8, thereby accessing the big box formed by the storages of the MFPs 1 to 5.

FIG. 7 shows in flowchart procedures of a data storage process performed by the CPU 601 of the management apparatus 7 in a case where SSDs are used as the storages of the MFPs 1 to 5.

In the data storage process of FIG. 7, the CPU 601 serving as a computation unit acquires the capacities of the provided areas of the SSDs of the MFPs 1 to 5 from the management table of FIG. 6 (step S101), and computes lifetime values of the provided areas of the SSDs, as will be described later (step S102).

Next, based on the computed lifetime values of the provided areas of the SSDs, the CPU 601 serving as a storage control unit specifies the use priority order of the provided areas of the SSDs (address regions of the big box), which are data storage destinations (step S103), and determines whether the CPU 601 receives from any of the PC 6 and the MFPs 1 to 5 a request for storing data into the big box (step S104). When receiving a data storage request (i.e., if YES to step S104), the CPU 601 controls the corresponding MFP such that data is stored into one of the provided areas of the SSDs which is determined according to the specified use priority order (step S105), whereupon the process returns to step S102.

There are a variety of methods for computing the lifetime values of the provided areas of the SSDs. In this embodiment, four methods will be described below in sequence.

In a first method, the lifetime value of the provided area of each SSD is computed according to the following formula (1).

Lifetime value=(Total amount of data stored up to now)/(Capacity of provided area) (1)

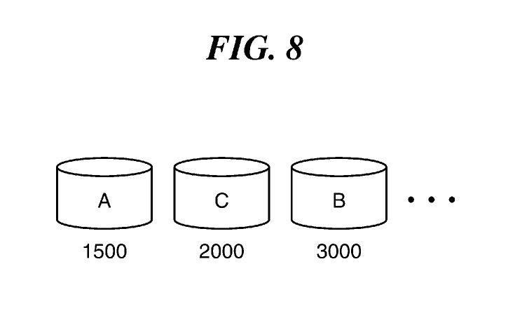

In formula (1), the term “total amount of data stored up to now” refers to an amount of use of the provided area of the SSD (i.e., total size of data temporarily stored in the provided area). The lifetime value is computed as being 1500, if the capacity of the provided area of the SSD is 20 GB and data of 30 TB has been temporarily stored up to now in the provided area. As the lifetime value becomes larger, it is indicated that the provided area has been well used. In a case, for example, that the lifetime values of provided areas A′ to C′ of SSDs are 1500, 3000, and 2000 respectively as shown in FIG. 8, the provided areas A′, C′, and B′ are specified in this order as data storage destinations.

In the first method, an amount of use of each provided area per unit capacity of the provided area is computed as the lifetime of the provided area. It is therefore possible to compare the lifetimes of provided areas with one another, even if the provided areas are different in capacity from one another.

In a second method, the lifetime value of the provided area of each SSD is computed according to the following formula (2).

Lifetime value=[{(Total amount of data stored up to now)/(Capacity of provided area)}/(Upper limit value of number of deletion times)]×100 (2)

In formula (2), the term “total amount of data stored up to now” refers to the amount of use of the provided area of the SSD (i.e., total size of data temporarily stored in the provided area). The upper limit value of the number of deletion times can be specified by the management apparatus 7 or by the user. The lifetime value in formula (2) indicates the ratio of the amount of use of the provided area per unit capacity of the provided area to the upper limit value of the number of deletion times. The lifetime value is computed as being 15% in a case where the upper limit value of the number of deletion times is 10000, the capacity of the provided area is 20 GB, and data of 30 TB has been temporarily stored up to now in the provided area. As the lifetime value becomes larger, it is indicated that the provided area has been well used. In the second method, the amount of use of each provided area per unit capacity of the provided area per unit upper limit value of the number of deletion times is computed as the lifetime of the provided area. It is therefore possible to compare the lifetimes of provided areas with one another, even if the provided areas are different from one another in the upper limit value of the number of deletion times.

In a third method, the lifetime value of the provided area of each SSD is computed according to the following formula (3).

Lifetime value={(Total amount of data stored up to now)/(Capacity of provided area)}/(Time of use of provided area up to now) (3)

In formula (3), the term “time of use of provided area up to now” refers to the total time of use of the provided area of the SSD. The lifetime value in formula (3) indicates the ratio of the amount of use of the provided area per unit capacity of the provided area to the time of use of the provided area of the SSD. The lifetime value is computed as being 1.5/hour in a case where the time of use of the provided area up to now is 1000 hours, the capacity of the provided area is 20 GB, and data of 30 TB has been temporarily stored up to now in the provided area. As the lifetime value becomes larger, it is indicated that the provided area has been well used. In the third method, the amount of use of each provided area per unit capacity of the provided area per unit time of use of the provided area is computed as the lifetime of the provided area. It is therefore possible to compare the lifetimes of provided areas with one another, even if the provided areas are different in time of use from one another. Based on a result of the comparison, the use frequencies of the provided areas of the SSDs can be equalized.

In a fourth method, the lifetime value of the provided area of each SSD is computed according to the following formula (4).

Lifetime value=[{(Total amount of data stored up to now)/(Capacity of provided area)}/(Upper limit value of number of deletion times)]×100/(Time of use of provided area up to now) (4)

The lifetime value in formula (4) indicates the ratio of the amount of use of the provided area per unit capacity of the provided area per unit upper limit value of the number of deletion times to the time of use of the provided area. The lifetime value is computed as being 0.15%/hour in a case where the time of use of the provided area up to now is 1000 hours, the upper limit value of the number of deletion times is 10000, the capacity of the provided area is 20 GB, and data of 30 TB has been temporarily stored up to now in the provided area. As the lifetime value becomes larger, it is indicated that the provided area has been well used. In the fourth method, the lifetime of the provided area is computed by dividing the amount of use of each provided area per unit capacity of the provided area per unit upper limit value of the number of deletion times by the time of use of the provided area. It is therefore possible to compare the lifetimes of provided areas with one another, even if the provided areas are different in time of use from one another. Based on a result of the comparison, the use frequencies of the provided areas of the SSDs can be equalized.

With the data storage process of FIG. 7, the lifetime values representing the lifetimes of provided areas are computed according to any of the first to fourth computing methods, and the MFPs 1 to 5 are controlled based on the computed lifetime values such that provided areas having longer remaining lifetimes are used for data storage with higher priority order. It is therefore possible to prevent a particular one or ones of the storage units (SSDs) from being concentratedly accessed, whereby the lifetimes of the storage units can be equalized.

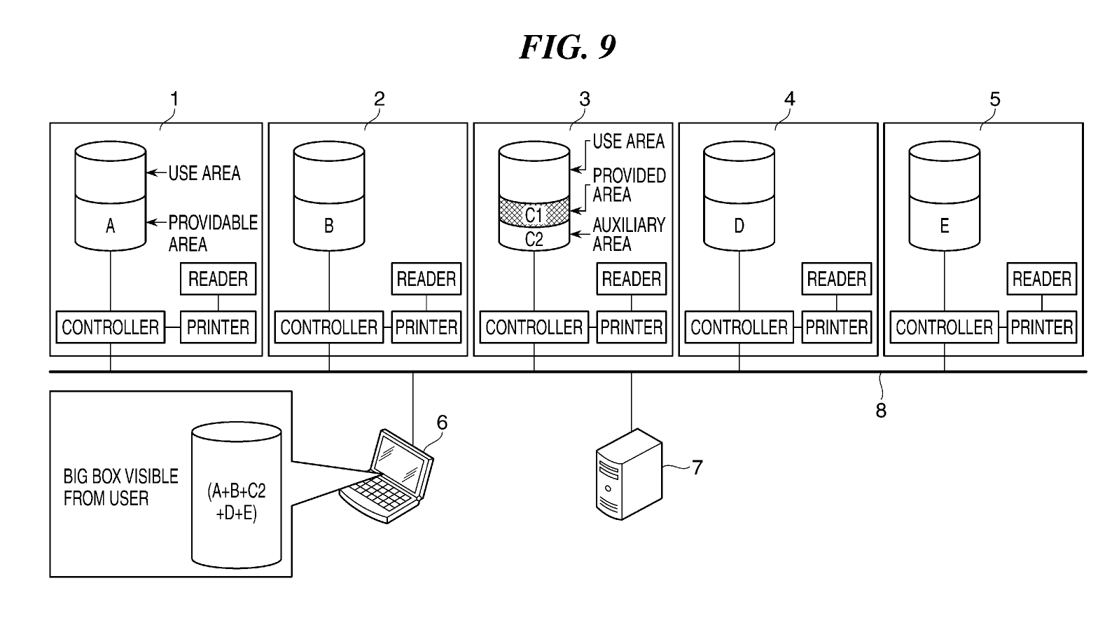

FIG. 9 shows a provided area changing process in which when the lifetime value of the provided area of any of the storages exceeds a predetermined value, the auxiliary area of the storage is set as a new provided area.

The provided area changing process is performed when any of the remaining lifetimes of the provided areas becomes short, even if the lifetimes of the provided areas have been equalized by executing the data storage process of FIG. 7.

In the example of FIG. 9, when the remaining lifetime of the provided area (shown by symbol C1) of the storage of the MFP 3 becomes short, the auxiliary area (shown by symbol C2) of the storage of the MFP 3 is set as a new provided area. The management apparatus 7 decides what portion of the auxiliary area C2 should be provided as a part of the big box, and updates the contents of the management table based on a result of the decision.

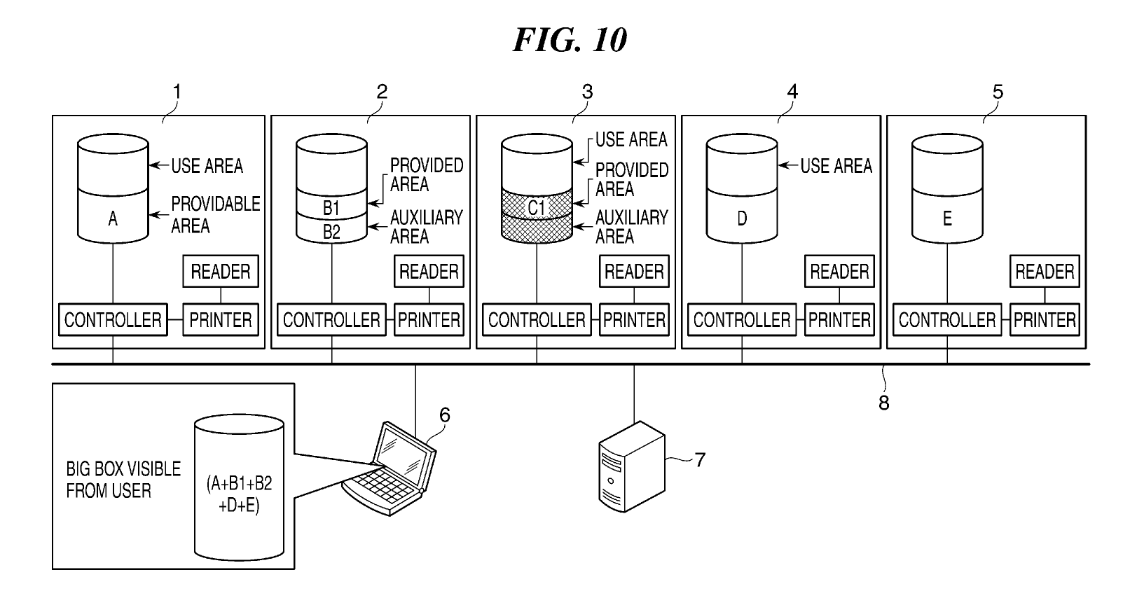

FIG. 10 shows a provided area changing process in which when the lifetime value of the providable area of the storage of any of the MFPs exceeds a predetermined value, the auxiliary area of the storage of another MFP is set as a new provided area.

In the example of FIG. 10, when the remaining lifetime of the providable area (provided area C1 and auxiliary area) of the storage of the MFP 3 becomes short, the auxiliary area B2 of the storage of the MFP 2 is set as a new provided area. The management apparatus 7 decides what portion of the auxiliary area B2 should be provided as a part of the big box, and updates the contents of the management table based on a result of the decision.

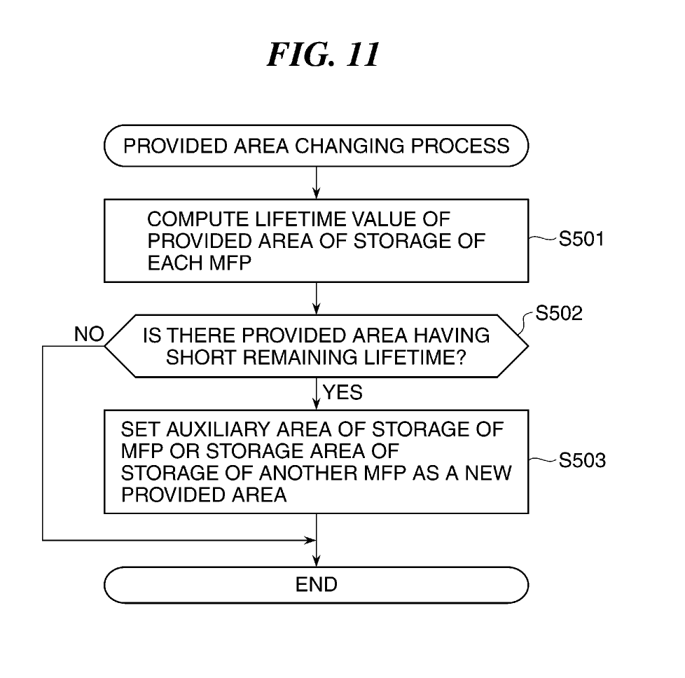

FIG. 11 shows, in flowchart, procedures of a provided area changing process executed by the CPU 601 of the management apparatus 7.

In the changing process of FIG. 11, the CPU 601 serving as a storage area changing unit computes lifetime values representing the lifetimes of the provided areas of the storage units (storages) of the MFPs 1 to 5 (step S501), and compares each of the computed lifetime values with a corresponding one of predetermined lifetime values determined according to types, durabilities, etc. of the storages, thereby determining whether there is any provided area having a short remaining lifetime (step S502). If the answer to step S502 is NO, the present process is completed. If there is a provided areas having a short remaining lifetime (i.e., if YES to step S502), another storage area (auxiliary area) of the storage unit of the MFP from which the provided area having the short remaining lifetime is provided or a storage area of the storage unit of another MFP is set as anew storage area (provided area) alternative to the provided area having the short remaining lifetime (step S503), whereupon the present process is completed.

With the provided area changing process of FIG. 11, if there is a provided area having a short remaining lifetime, a new provided area alternative thereto is set. It is therefore possible to stably ensure the capacity of the big box.

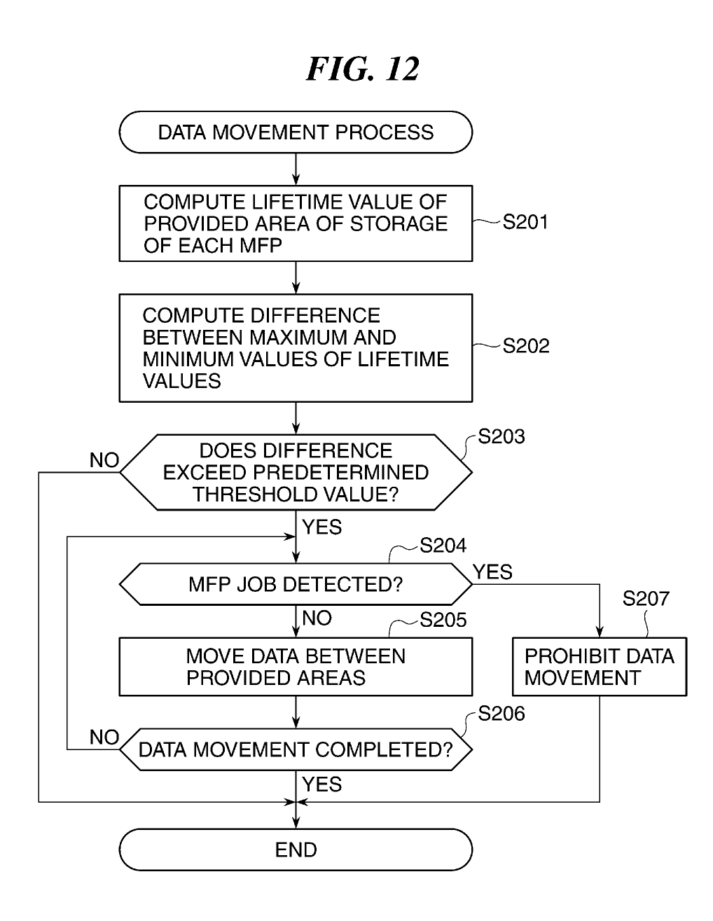

FIG. 12 shows, in flowchart, procedures of a data movement process executed by the CPU 601 of the management apparatus 7.

In the data movement process of FIG. 12, the CPU 601 acquires lifetime values of the provided areas of the storages of the MFPs 1 to 5 (step S201), computes a difference between maximum value and minimum value of the acquired lifetime values (step S202), and determines whether or not the computed difference exceeds a predetermined threshold value (step S203). The predetermined threshold value is determined according to types, durabilities, etc. of the storages of the MFPs 1 to 5 such that the lifetime values of the provided areas of these storages can be equalized.

If it is determined in step S203 that the difference between the maximum and minimum values of the acquired lifetime values does not exceed the predetermined threshold value (i.e., if NO to step S203), the present process is completed. If the difference between the maximum and minimum values of the acquired lifetime values exceeds the predetermined threshold value (i.e., if YES to step S203), the CPU 601 determines whether or not it detects an MFP job (step S204).

When detecting an MFP job (i.e., if YES to step S204), the CPU 601 serving as a data movement unit prohibits data movement since an error can occur, such as unconformity of data or absence of data, if data is moved when the MFP job is being executed and hence there is a high possibility of the data being used (step S207), whereupon the present process is completed. When not detecting an MFP job (i.e., if NO to step S204), the CPU 601 moves data from the provided area having the minimum lifetime value to the provided area having the maximum lifetime value (step S205), and determines whether or not the data movement is completed (step S206). If the data movement is completed (i.e., if YES to step S206), the present process is completed.

According to the data movement process of FIG. 12, if the difference between the lifetime value of the provided area having the shortest remaining lifetime and that of the provided area having the longest remaining lifetime exceeds the predetermined threshold value, data stored in the provided area having the shortest remaining lifetime is moved to the provided area having the longest remaining lifetime. It is therefore possible to prevent a particular one or ones of the storage units from being concentratedly accessed, whereby the lifetimes of the storage units can be equalized.

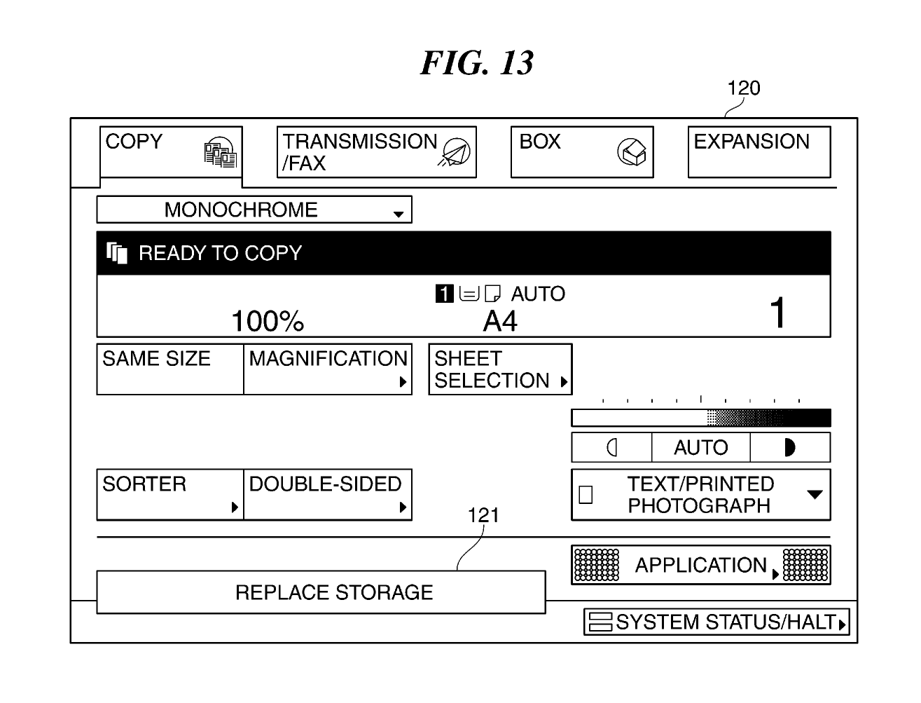

FIG. 13 shows an example of a warning that is displayed on the operation unit 120 of the MFP 1.

Referring to FIG. 13, when the lifetime value of any of the provided areas or the lifetime value of any of the providable areas reaches the predetermined value, a warning 121 is displayed on the operation unit 120 to prompt the user to replace the corresponding storage. After replacement of the storage, the lifetime value of the provided area or the providable area of the storage after replacement is reset.

In accordance with the warning, the user is able to know the timing of replacement of storage, whereby the user-friendliness of the MFP can be improved.

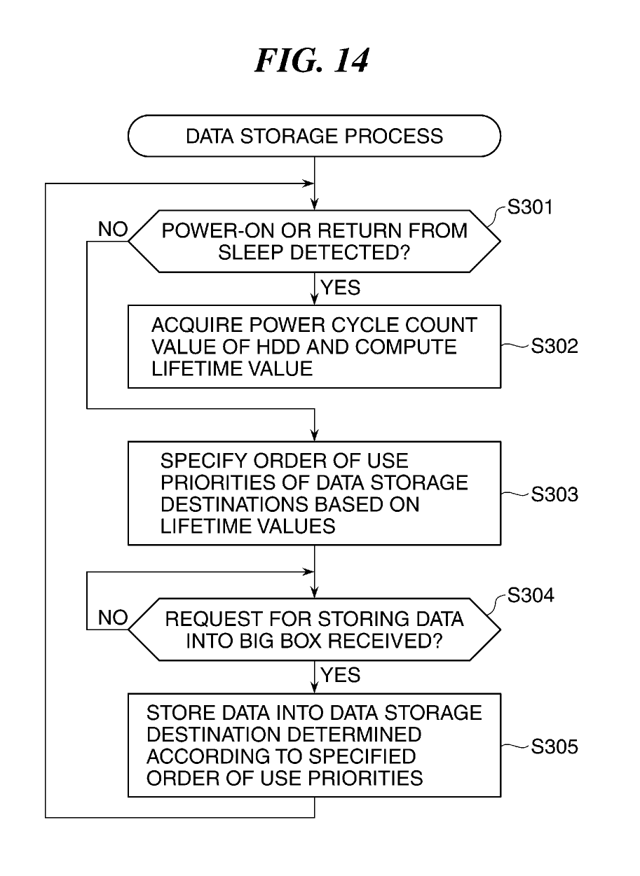

FIG. 14 shows, in flowchart, procedures of a data storage process executed by the CPU 601 of the management apparatus 7 in a case where HDDs are used as the storages of the MFPs.

In the data storage process of FIG. 14, the CPU 601 determines whether or not it detects power-on of any of the HDDs or return of any of the HDDs from sleep (step S301). If the answer to step S301 is NO, the process proceeds to step S303. On the other hand, if the answer to step S301 is YES, the CPU 601 acquires a power cycle count value of the HDD, and computes a lifetime value of the provided area of the HDD based on the acquired power cycle count value (step S302). The power cycle count value represents the number of power ON/OFF times of the HDD and can be acquired by an SMART (Self-Monitoring Analysis and Reporting Technology) function.

Next, the CPU 601 specifies the order of use priorities of the provided areas of the HDDs (data storage destinations) based on the lifetime values of the provided areas (step S303), and determines whether or not the CPU 601 receives a request for data storage into the big box from any of the PC 6 and the MFPs 1 to 5 (step S304). When receiving a data storage request (i.e., if YES to step S304), the CPU 601 stores data into the provided area of the HDD (data storage destination) determined according to the specified order of use priorities (step S305), and returns to step S302.

With the data storage process of FIG. 14, the lifetime values of the provided areas of the HDDs are computed based on the power cycle count values acquired by the SMART function, and the order of use priorities of the provided areas of the HDDs is specified in descending order of lifetime values. It is therefore possible to equalize the numbers of ON/OFF times of the HDDs, whereby the lifetimes of the HDDs can be equalized.

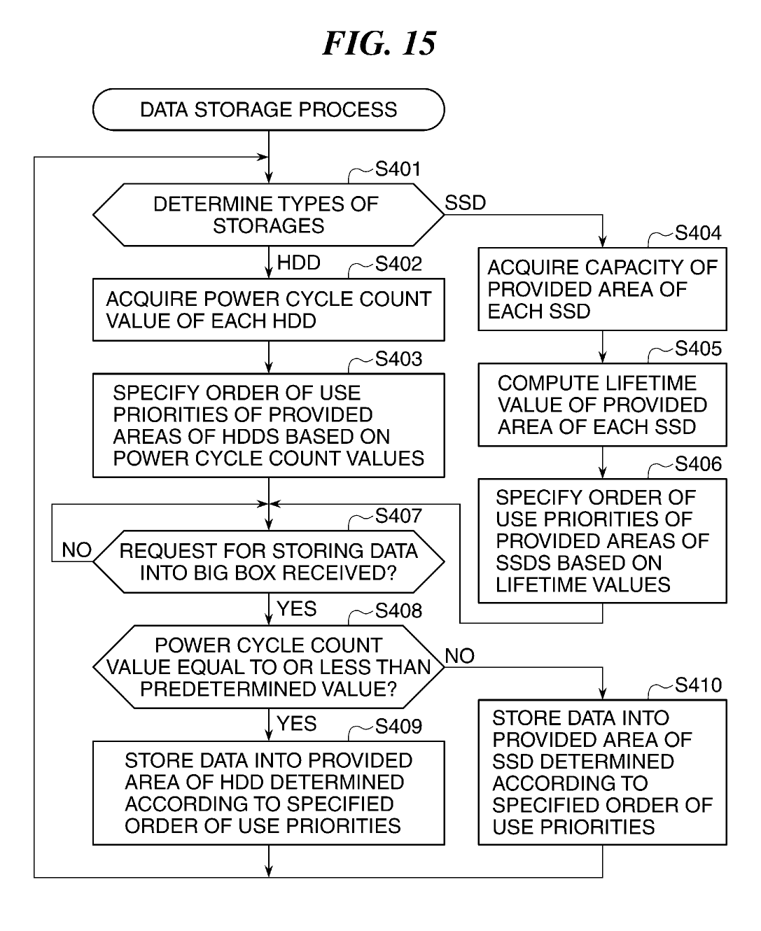

FIG. 15 shows, in flowchart, procedures of a data storage process executed by the CPU 601 of the management apparatus 7 in a case where HDDs and SSDs are used as the storages of the MFPS with a higher priority to the HDDs than to SSDs.

In the data storage process of FIG. 15, the CPU 601 determines types of storages of the MFPs 1 to 5 (step S401). If the type of one or more of the storages is determined as being HDD, the CPU 106 acquires power cycle count values of the HDDs (step S402), specifies the order of use priorities of provided areas of the HDDs (data storage destinations) based on the acquired power cycle count values (step S403), and proceeds to step S407.

If it is determined in step S401 that the type of one or more of the storages is SSD, the CPU 601 acquires information representing the capacities of the provided areas of the SSDs from the management table (step S404), computes the lifetime values of provided areas of the SSDs in the same computation method as that in step S102 of FIG. 7 (step S405), and specifies the order of use priorities of the provided areas of the SSDs (data storage destinations) based on the computed lifetime values (step S406). Then, the process proceeds to step S407 where it is determined whether or not a request for data storage into the big box is received from any of the PC 6 and the MFPs 1 to 5.

When receiving a data storage request (i.e., if YES to step S407), the CPU 601 determines whether or not, among the power cycle count values acquired in step S402, at least the power cycle count value of the provided area of the HDD having the highest priority in terms of the order of use priorities specified in step S403 is equal to or less than the predetermined value (step S408). If the answer to step S408 is YES, data is stored into the provided area of the HDD determined according to the specified order of use priorities, i.e., into the provided area of the provided area having the highest use priority (step S409), whereupon the process returns to step S401.

If it is determined in step S408 that each of all the acquired power cycle count values is not equal to nor less than the predetermined value (i.e., if NO to step S408), data is stored into the provided area of the SSD determined according to the specified order of use priorities (step S410), and the process returns to step S401.

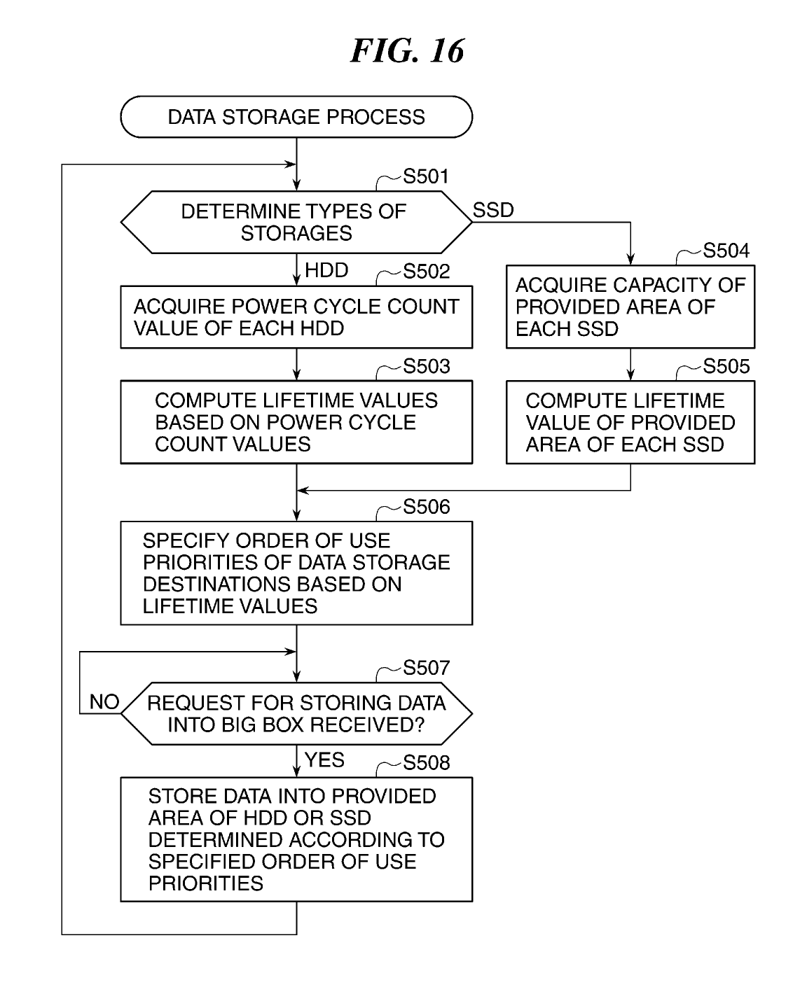

FIG. 16 shows, in flowchart, procedures of a data storage process executed by the CPU 601 of the management apparatus 7 in a case where HDDs and SSDs are used as the storages of the MFPs with a higher priority to either HDDs or SSDs, whichever have longer lifetime values.

In the data storage process of FIG. 16, the CPU 601 determines the types of storages of the MFPs 1 to 5 (step S501). If the type of one or more of the storages is determined as being HDD, the CPU 601 acquires power cycle count values of the HDDs (step S502), computes lifetime values of the HDDs based on the acquired power cycle count values, as will be described later (step S503), and proceeds to step S506.

If it is determined in step S501 that the type of one or more of the storages is SSD, the CPU 601 acquires information representing the capacities of the provided areas of the SSDs from the management table (step S504), computes lifetime values of the provided areas of the SSDs in the same computation method as that in step S102 of FIG. 7 (step S505), and proceeds to step S506.

In step S506, the CPU 601 specifies the order of use priorities of the provided areas of the HDDs and the SSDs (data storage destinations) based on the computed lifetime values. Next, it is determined whether a request for data storage into the big box is received from any of the PC 6 and the MFPs 1 to 5 (step S507). When receiving a data storage request (i.e., if YES to step S507), data is stored into the provided area of the HDD or the SSD determined according to the specified order of use priorities (step S508), whereupon the process returns to step S501.

The following is a description of how lifetime values of HDDs are computed in step S503.

The CPU 601 computes remaining lifetime values of provided areas of the HDDs based on the power cycle count values acquired in step S502 and an upper limit value of power cycle count. The upper limit value of power cycle count can be instructed by the management apparatus 7 or by the user. There are a variety of methods for computing the lifetime values. In this embodiment, two methods will be described below.

In a first method, the lifetime value of the provided area of each HDD is computed according to the following formula (5).

Lifetime value={(Current power cycle count value)/(Upper limit value of power cycle count)}×100 (5)

The remaining lifetime value is computed as being 12% in a case, for example, that the upper limit value of power cycle count is 50000 and the current power cycle count value is 6000.

In the first method, the ratio of the current power cycle count value to the upper limit value of power cycle count is computed as the lifetime value. It is therefore possible to compare the lifetimes of HDDs with one another, even if the HDDs are different in upper limit value of power cycle count (i.e., HDD type) from one another.

In a second method, the lifetime value of the provided area of each HDD is computed according to the following formula (6).

Lifetime value=[{(Current power cycle count value)/(Upper limit value of power cycle count)}×100]/(Time of use of HDD up to now) (6)

The lifetime value is computed as being 0.012%/hour in a case, for example, that the time of use of HDD up to now is 1000 hours, the upper limit value of power cycle count is 50000, and the current power cycle count value is 6000.

In the second method, the ratio of the current power cycle count value per unit upper limit value of power cycle count to the time of use is computed as the lifetime value. It is therefore possible to compare the lifetimes of HDDs with one another, even if the HDDs are different in type and in time of use from one another.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-264957, filed Nov. 29, 2010, which is hereby incorporated by reference herein in its entirety.

What is claimed is:

1. A storage area management apparatus for managing, as one storage area, a plurality of storage areas respectively provided from nonvolatile storage units of respective ones of upper apparatuses, comprising:
a computation unit configured to compute lifetime values representing lifetimes of the plurality of storage areas; and
a storage control unit configured to control the upper apparatuses based on the lifetime values computed by said computation unit such that storage areas having longer remaining lifetimes, among the plurality of storage areas, are used for data storage with higher priority order.

2. The storage area management apparatus according to claim 1, further including:
a storage area changing unit configured, in a case where any of the plurality of storage areas has a short remaining lifetime less than a predetermined lifetime, to set another storage area of that storage unit of one of the upper apparatuses which provides the storage area having the short remaining lifetime or a storage area of the storage unit of another one of the upper apparatuses, as a new storage area alternative to the storage area having the short remaining lifetime.

3. The storage area management apparatus according to claim 1, further including:
a data movement unit configured, in a case where a difference between maximum and minimum values of the lifetime values computed by said computation unit exceeds a predetermined threshold value, to move data in one of the plurality of storage areas that has a shortest remaining lifetime to another one of the plurality of storage areas that has a longest remaining lifetime.

4. The storage area management apparatus according to claim 3, wherein in a case where there is a possibility that data in the storage area having the shortest remaining lifetime is used by one of the upper apparatuses that provides the storage area having the shortest remaining lifetime, said data movement unit prohibits data movement from the storage area having the shortest remaining lifetime.

5. The storage area management apparatus according to claim 1, wherein in a case where any of the storage units is a hard disk drive, said computation unit computes the lifetime of the storage area provided from the storage unit based on a power cycle count acquired by a SMART function.

6. The storage area management apparatus according to claim 1, wherein in a case where any of the plurality of storage units is an SSD, said computation unit computes the lifetime of the storage area provided from the storage unit based on a capacity of the storage area and a total size of data temporarily stored in the storage area.

7. A control method for a storage area management apparatus for managing, as one storage area, a plurality of storage areas respectively provided from nonvolatile storage units of respective ones of upper apparatuses, comprising:
a computation step of computing lifetime values representing lifetimes of the plurality of storage areas; and
a storage control step of controlling the upper apparatuses based on the lifetime values computed in said computation step such that storage areas having longer remaining lifetimes, among the plurality of storage areas, are used for data storage with higher priority order.

8. A non-transitory computer-readable storage medium storing a program for causing a computer to execute the control method as set forth in claim 7.
